(19) United States
(12) Patent Application Publication
(10) Pub. No.: US 2013/0185101 A1
(43) Pub. Date: Jul. 18, 2013

(54) System, Method, and Computer Program Product for Underwriting Mortgage Loan Insurance

(71) Applicant: AMERICAN INTERNATIONAL GROUP, INC., New York, NY (US)

(72) Inventors: Kim Garland, Greensboro, NC (US); William Hamilton, Greensboro, NC (US); Hope Evans, Greensboro, NC (US); John Gaines, Greensboro, NC (US); Jayendra Balasubramanian, Greensboro, NC (US); Mark Figley, Greensboro, NC (US)

(73) Assignee: AMERICAN INTERNATIONAL GROUP, INC., New York, NY (US)

(21) Appl. No.: 13/744,210

(22) Filed: Jan. 17, 2013

Related U.S. Application Data
(60) Provisional application No. 61/587,495, filed on Jan. 17, 2012.

(51) Int. Cl. G06Q 40/08

(52) U.S. Cl. CPC G06Q 40/08; G06Q 40/025
USPC 705/4

(57) ABSTRACT

Underwriting systems and methods include a non-transitory, tangible computer-readable storage medium bearing instructions for performing underwriting steps for a mortgage insurance product for a mortgage between a borrower and a lender. A processor is adapted to execute an underwriting program contained on the computer-readable medium. A web-enabled interface is adapted to exchange information with partner sites, including to receive loan information, to send mortgage insurance information generated by the underwriting program, and to receive borrower credit information. The underwriting program includes a post-closing underwriting module adapted to perform a post-closing fraud analysis using the loan information received through the web-enabled interface and adapted for use in performing at least a portion of a post-closing borrower credit review using the borrower credit information received through the web-enabled interface within a predetermined period of time after the loan has closed and before a claim under the mortgage insurance product has been received.

### CROSS-REFERENCE TO RELATED APPLICATIONS

This patent application claims the benefit of priority to U.S. Provisional Patent Application No. 61/587,495, filed on Jan. 17, 2012, and entitled “System, Method, and Computer Program Product for Underwriting Mortgage Loan Insurance,” which is incorporated in its entirety herein by this reference.

### TECHNICAL FIELD

This patent disclosure relates generally to a system, method, and computer product for underwriting. More particularly, the disclosure relates to a system, method, and computer product for underwriting mortgage insurance products.

### BACKGROUND

The mortgage industry conventionally relies on a system of representations and warrants where minimal loan validation is done upfront. This approach can allow loans without the proper documentation, loans with quality defects, and fraudulent loans into an insurance provider's coverage portfolio. Under the conventional model, detailed data verification and fraud reviews are conducted at the time a claim is made, potentially delaying the payment of a claim and leading to possible coverage gaps if documentation issues, quality defects or fraud issues are detected. Flaws in the conventional model can negatively impact all of the participants in the housing market and mortgage industry.

It will be appreciated that this background description has been created by the inventors to aid the reader, and is not to be taken as an indication that any of the indicated problems were themselves appreciated in the art. While the described principles can, in some respects and embodiments, alleviate the problems inherent in other systems, it will be appreciated that the scope of the protected innovation is defined by the attached claims, and not by the ability of any disclosed feature to solve any specific problem noted herein.

### BRIEF SUMMARY

Various aspects of the disclosure describe a computer-implemented system, a method and a non-transitory, tangible computer-readable storage medium bearing instructions for underwriting a mortgage insurance product. In one aspect, a computer-implemented system for underwriting includes a physical computer-readable medium including an underwriting program and a processor adapted to execute the underwriting program contained on the physical computer-readable medium.

Embodiments of the disclosure move the validation for insurance toward the origination process instead of the claim process. Determination of coverage eligibility upfront, prior to a claim being filed, helps prevent ineligible loans from being insured thereby allowing for a more efficient utilization of the insurer's capital. Upfront eligibility determination also helps avoid customer relationship issues generated by rescinding coverage at the time of claim under an ineligible loan.

Utilization of fraud tool computer programs during the upfront validation process can assist in detecting fraud during the underwriting process. Electronic communication channels can be established between an insurer and a lender to allow for rapid and accurate transmission of loan closing documentation. Electronic communication channels can be established between the insurer and a borrower information source (such as an information source that provides credit history information about a borrower) to allow the insurer to perform further fraud analysis within a predetermined time period after the loan is closed. Robust system edits can ensure that a loan is compliant with the insurer's underwriting guidelines. Post-closing loan reviews can help ensure that data submitted for underwriting was consistent with the final terms of the loan transaction.

In one arrangement, a computer-implemented system for underwriting a mortgage insurance product includes a physical computer-readable medium including an underwriting program with a fraud scorecard module and a processor adapted to execute the underwriting program. A web-enabled interface is adapted to exchange information between the insurer and a lender to receive information regarding the underlying loan issued by the mortgagor and the insurer and a borrower information source including to receive information regarding the mortgagee's credit history information.

In one embodiment, a processor is adapted to execute an underwriting program contained on the computer-readable medium. A web-enabled interface is adapted to exchange information with partner sites, including to receive loan information, to send mortgage insurance information generated by the underwriting program, and to receive borrower credit information. The underwriting program includes a post-closing underwriting module adapted to perform a post-closing fraud analysis using the loan information received through the web-enabled interface and adapted for use in performing at least a portion of a post-closing borrower credit review using the borrower credit information received through the web-enabled interface within a predetermined period of time after the loan has closed and before a claim under the mortgage insurance product has been received.

In another aspect, a method for underwriting a mortgage insurance product includes employing a processor to execute computer executable instructions stored on a tangible computer-readable medium to perform steps for underwriting. In one embodiment, a method for underwriting a mortgage insurance product for a mortgage between a borrower and a lender is described. Loan information regarding the mortgage is received through a network including a web-enabled interface. A processor is employed to execute computer-executable instructions stored on a physical computer-readable medium. The computer-executable instructions perform underwriting steps. A post-closing fraud analysis is performed within a predetermined time range after the mortgage closed and before a claim under the mortgage insurance product has been received using the received loan information. Borrower credit information is received through the network within the predetermined time range after the mortgage closed. At least a portion of a post-closing borrower credit review is performed using the received borrower credit information.

In still another aspect, a non-transitory, tangible computer-readable storage medium is described. The medium bears instructions, which, when executing on one or more computing devices, perform underwriting steps for a mortgage insurance product.

In one embodiment, a non-transitory, tangible computer-readable storage medium bearing computer executable instructions for underwriting a mortgage insurance product for a mortgage between a borrower and a lender. The instructions, when executing on one or more computing devices, performing underwriting steps. A post-closing fraud analysis using loan information collected from a plurality of data fields is performed within a predetermined time range after the mortgage closed and before a claim under the mortgage insurance product has been received. Borrower credit information is received within the predetermined time range after the mortgage closed. At least a portion of a post-closing borrower credit review is performed using the received borrower credit information.

Further and alternative aspects and features of the disclosed principles will be appreciated from the following detailed description and the accompanying drawings. As will be appreciated, the principles related to underwriting a mortgage insurance product disclosed herein are capable of being carried out in other and different embodiments, and capable of being modified in various respects. Accordingly, it is to be understood that both the foregoing general description and the following detailed description are exemplary and explanatory only.

### BRIEF DESCRIPTION OF THE DRAWINGS

FIG. 1 is a flow diagram of an exemplary embodiment of a method of underwriting a mortgage insurance product.

FIG. 2 is a flow diagram of an exemplary embodiment of steps for evaluating a mortgage loan for fraud suitable for use in a method of underwriting a mortgage insurance product.

FIGS. 3A and 3B are a flow diagram of an exemplary embodiment of a method of underwriting a mortgage insurance product.

FIG. 4 is a schematic view of an exemplary embodiment of a system in keeping with principles of the present disclosure.

### DETAILED DESCRIPTION OF UNDERWRITING EMBODIMENTS

This disclosure relates to embodiments of a computer-implemented underwriting system that allows an insurance provider to perform upfront validation analysis prior to a claim being filed under the issued mortgage insurance product through an underwriting application stored upon a non-transitory tangible computer-readable medium in operable arrangement with a processor adapted to execute the underwriting application. In one embodiment, the underwriting application is stored upon a non-transitory, tangible computer-readable medium and operably arranged with a processor. The processor is communicatively connected to one or more servers of partner entities that provide information relating to the mortgagor (lender) and/or the mortgagee (borrower). The processor is adapted to execute the underwriting application.

Embodiments of the underwriting system according to the present disclosure are designed to help avoid the shortcomings of the existing “reps and warrants” model, and to help prevent “bad loans” from being originated or insured. Embodiments of the underwriting system according to the present disclosure can provide lenders with increased assurance that its insured mortgages have valid coverage in the event of a claim.

Embodiments of the underwriting method according to the present disclosure are adapted to address areas that typically lead to mortgage insurance coverage being rescinded or cancelled under the current “reps and warrants” model. These areas can include a lack of documentation, underwriting defects, and fraud.

### Lack of Documentation

The underwriting method can ensure that loan files are complete. Lenders provide the insurer with electronic access to loan documentation. The loan documentation can include origination documents; closing documents; and servicing, payment and collection history documents. Origination and closing documents are reviewed and stored by the insurer during the underwriting and post closing review process. The lender can submit servicing, payment, and collection history documents to the insurer at the time of claim.

In embodiments of the underwriting method of the present disclosure, mortgage insurance commitments will not be issued for loans with incomplete origination documents. Coverage will be cancelled on loans in which closing documents are not provided. A lender will bear the risk of coverage cancellation if servicing documents are not provided or if a loan has not been serviced in accordance with the terms of a Master Policy between the insurance company and the lender.

The underwriting program can significantly reduce the possibility of “bad” loans being underwritten and insured. In embodiments of the underwriting method of the present disclosure, a full-file, front-end verification underwriting process can occur prior to closing the loan and a post-closing review can take place within a predetermined period of time after the loan has closed. The loan is evaluated at the time of origination. The information collected at origination can be accomplished through robust data fields of the underwriting program over a graphical user interface. Copies of loan origination documents are provided in an electronic format and maintained in an electronic common repository. The underwriting program can include an optical character recognition tool to convert electronic documents submitted to the insurer into a computer-readable and searchable format for a suitable word-processing program.

Closing documents are reviewed to ensure that the loan actually made is the same as or substantially similar to the loan originally evaluated. If there is a defect, a predetermined, previously-agreed upon defect resolution process flow can be followed to efficiently and predictably respond to the identified defect. Following a method using principles of the present disclosure can help prevent the insurer from issuing ineligible loans. As a result, the insurance company can obtain greater capital efficiency by avoiding holding capital in reserves against an ineligible loan.

### Underwriting Defects

In embodiments of the underwriting method of the present disclosure, a predetermined period of time is reserved for a post-closing review of the loan. The period of time is within a range of time between the loan being closed and prior to a claim being filed for that loan. In the illustrated embodiments, a three-month period is reserved to review documentation and confirm loan transaction specifics.

Performing the post-closing re-underwrite process after the loan is closed but prior to a claim being filed can provide greater certainty of coverage for the insured. In embodiments of an underwriting method of the present disclosure, each loan can go through a thorough up-front underwriting process, as well as a post-closing review to ensure loan, data, and document integrity. The insurer can evaluate each loan for compliance with the insurer's guidelines and apply additional data verification and fraud detection tools as part of the underwriting process. The insurer can have a predetermined period of time (e.g., a ninety-seven day period) to review loan documentation after the loan closes.

The insurer's guidelines and other controlling terms can be established in a Master Policy issued by the insurer for a specified lender. The Master Policy can include terms that are generally applicable to all insurance mortgage products issued by the insurer for loans by the specified lender. In other embodiments, the insurer's eligibility guidelines and other controlling terms can be established in another manner.

In the event that the insurer determines that data determined to be material to the mortgage insurance product issued has changed between the initial underwrite and the post-closing review, then: (1) if the loan is still within eligibility guidelines or within underwriting loan level exception authority, then coverage can be maintained (however, the loan may be re-priced so that the premium increases); or (2) if the loan does not meet eligibility or exception authority or closing documents reveal fraud, then coverage can be rescinded. Lenders remain accountable for servicing the loan. In some embodiments, the terms for servicing the loan are set forth in a Master Policy issued by the insurer to the lender.

### Fraud

In embodiments of the underwriting method of the present disclosure, loan application data can be utilized to evaluate the loan for fraud. In some embodiments, loan application data is evaluated using an underwriting program product having a fraud detection module contained on a physical computer-readable medium and a processor adapted to execute the underwriting program. In some embodiments, the fraud detection module can be adapted to generate an automated fraud score based upon the loan application data. In some embodiments, the loans in which the fraud score is at or exceeds a threshold value can be subjected to further fraud detection steps, including running the application data through another computer program fraud detection module and performing a more extensive review of the flagged loans. Any suitable fraud detection program can be used. In embodiments, a suitable fraud detection module can be similar to those described in U.S. Pat. Nos. 8,121,920; 7,599,882; and 7,546,271 and commercially-available mortgage fraud detection software programs from Avantus LLC of West Haven, Conn. under the name Loan Shield or from CoreLogic of Irvine, Calif., under the name LoanSafe Fraud Manager, for example.

In embodiments of the underwriting method of the present disclosure, the insurer can use third-party data sources to verify loan application data. In some embodiments, electronic communication channels can be used by the insurer to obtain information about the borrower to verify the loan application data through an independent third party.

In embodiments of the underwriting method of the present disclosure, the insurer can use a calendar module of the underwriting program to schedule the ordering of a credit report for the borrower at a predetermined point in time after the borrower's loan has closed. By scheduling the credit report order date after an amount of time has passed since the loan has closed, the insurer can enhance its fraud detection capabilities by allowing the passage of time to reveal some credit history problems that may not yet have surfaced or may have been somehow obscured temporarily by the borrower prior to the loan closing. For example, the borrower may have undisclosed mortgage debt that emerges on the credit report run after the loan has closed.

In the illustrated embodiments, the calendar module schedules a credit report order about ninety days after the loan has closed. Preferably, the period of time within which the credit report is ordered is a sufficient amount of time to allow some further credit history to be generated by the borrower. In some embodiments, the order date for the credit history report can be scheduled from about sixty days to about one hundred twenty days after the borrower's loan has closed, and in other embodiments, from about sixty days to about ninety days after the borrower's loan has closed.

In embodiments of the underwriting method of the present disclosure, the underwriting program can include a monitoring module that determines whether the borrower has made a predetermined number of consecutive payments during the loan maintenance phase. Once a loan has reached the predetermined period of time in the loan maintenance phase, the conditions under which coverage can be denied can be narrowed in a predetermined manner.

In some embodiments, the definition of first party fraud, which if met would nullify coverage, can be narrowed. For example, in the illustrated embodiments, the definition of first-party fraud can be narrowed to include only fraud committed by a lender employee or officer.

In the illustrated embodiments, the monitoring module determines whether the borrower has made twelve consecutive monthly payments on the loan in a timely manner. In many situations where fraud has occurred in a loan, a claim is filed within the first year of closing the loan.

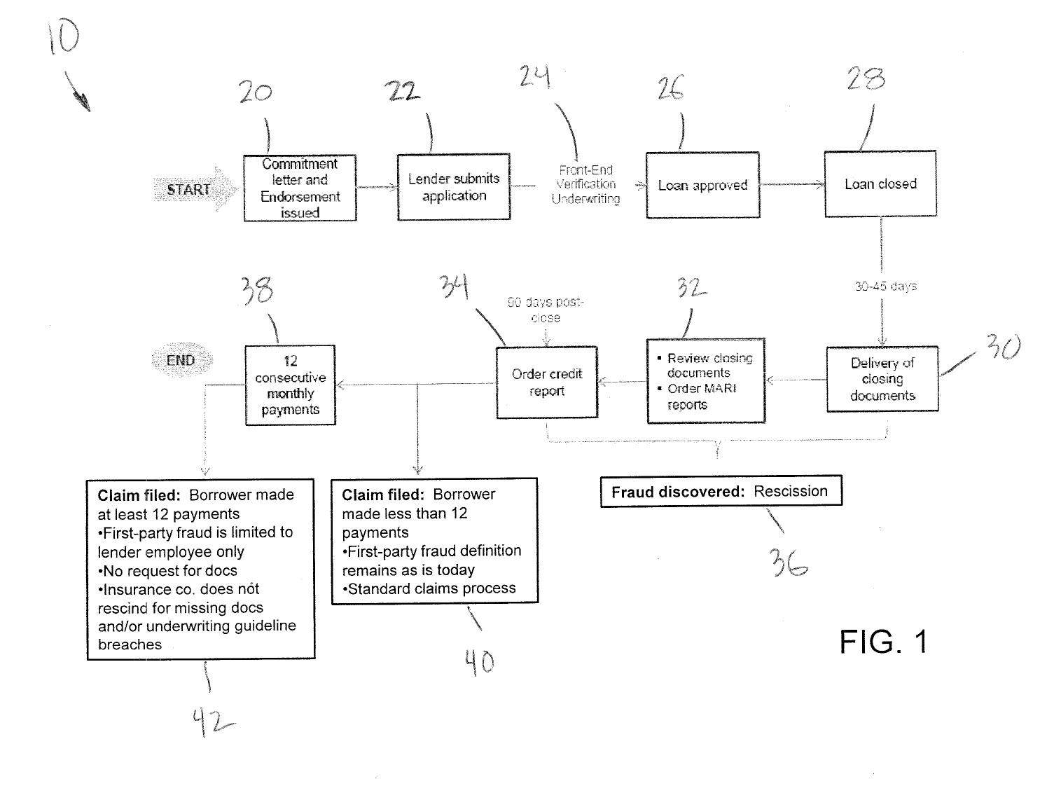

Turning now to the Figures, there is shown in FIG. 1, an embodiment of a method 10 of underwriting a mortgage insurance product according to principles of the present disclosure. A commitment letter and endorsement can be issued (step 20). A lender can submit an electronic set of loan application documents through a web-enabled interface for storage in a data storage device of the insurance company issuing the mortgage insurance products (step 22). The insurance company can conduct front-end verification underwriting techniques to determine whether to issue the mortgage insurance product and at what price structure (step 24). Once the loan is approved (step 26), the loan can be scheduled for closing (step 28). The mortgage insurance product can be issued at that time.

Within a predetermined amount of time (e.g., within thirty to forty-five days), an electronic set of closing documents can be sent to the insurance company (step 30). The insurance company can initiate a post-closing underwriting process which occurs within a predetermined period of time after the loan has closed and before a claim under the mortgage insurance product has been received. An electronic set of the loan origination documents and an electronic set of the loan closing documents for the mortgage can be stored in a data storage device operably arranged with a processor which executes an embodiment of an underwriting program constructed in accordance with principles of the present disclosure. The electronic set of closing documents can be compared to the electronic set of loan origination documents to determine whether any differences constituting a defect are present (step 32). In one arrangement, a fraud analysis report relating to the mortgage under review can also be ordered from a partner site, such as, a MARI report from the Mortgage Asset Research Institute, for example.

Within the predetermined time range (e.g., at about ninety days), borrower credit information can be ordered from a partner site (step 34). The borrower credit information can be embodied in an electronic file. In one arrangement, the credit information can be in the form of an electronically-formatted credit history which can include a plurality of data fields populated with values relating to that particular borrower's credit history and rating. The borrower credit information can be stored in the data storage device associated with the underwriting processor.

The borrower credit information, the third party fraud evaluation, and the closing document review can be used as part of a post-closing fraud review which occurs after closing but prior to the filing of a claim under the mortgage insurance product. If fraud is detected (step 36), the mortgage insurance product can be rescinded.

If the post-closing re-underwriting process does not establish any defects or evidence of fraud, the mortgage insurance product can enter a loan maintenance phase. The underwriting program can be used to determine whether the borrower has made a predetermined number of consecutive payments during the loan maintenance phase (step 38). In the illustrated embodiment, the predetermined number of consecutive payments is twelve. It will be appreciated that in other embodiments, the predetermined number of consecutive payments can be different.

If a claim is filed prior to the predetermined number of consecutive payments having been made (step 40), no changes to the coverage conditions under mortgage insurance product are made. However, if the borrower has made the predetermined number of consecutive payments prior to filing a claim (step 42), a set of conditions under which coverage under the mortgage insurance product is denied can be narrowed in a predetermined manner. For example, in the illustrated embodiment, the definition of first-party fraud is limited to a lender employee only, no request for documents will be made, and the insurance company will not rescind coverage for missing documents and/or underwriting guideline breaches.

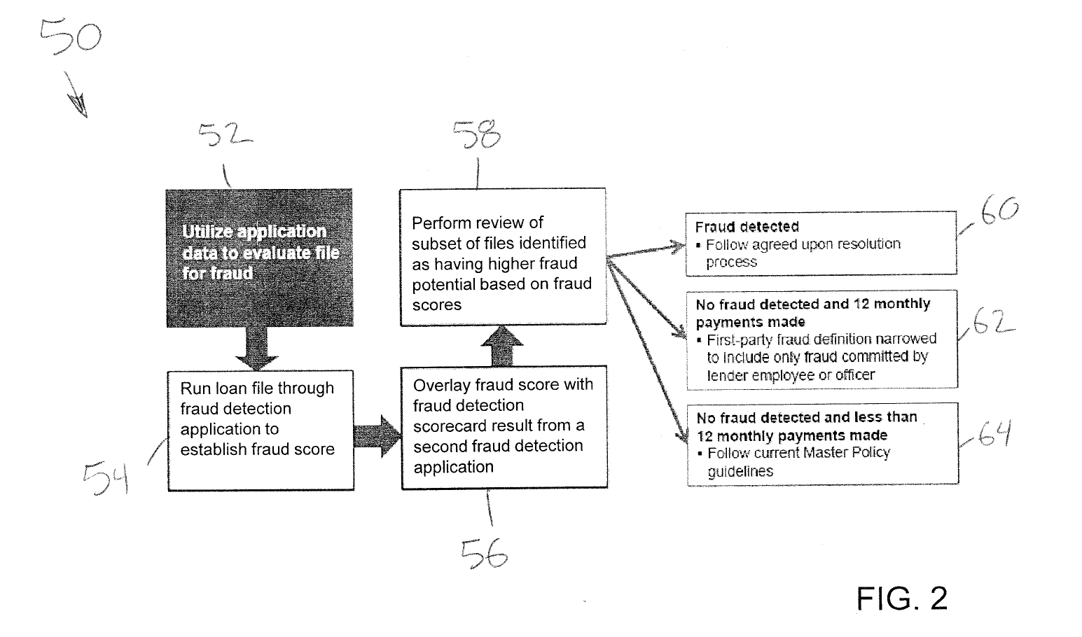

Referring to FIG. 2, an embodiment of a post-closing fraud evaluation 50 is shown that is suitable for use in embodiments of a method of underwriting a mortgage insurance product according to principles of the present disclosure. Loan application data can be used to evaluate the loan for fraud (step 52). Electronic loan information collected by the underwriting program through data fields presented in a graphical user interface can be loaded into a fraud detection module of the underwriting program to establish a fraud score (step 54).

The fraud score from step 54 can be overlaid with a fraud detection scorecard result from a second fraud detection application (step 56). In embodiments, the second fraud detection analysis can be performed by a partner site that receives the loan information from the underwriting program through a web-enabled interface. A review of a subset of files identified as having a higher fraud potential based upon an analysis of the two fraud scores can be performed (step 58).

If fraud is detected (step 60), the insurance company can follow a predetermined resolution process, including rescinding the mortgage insurance product. If no fraud is detected and a predetermined number (e.g., twelve) of monthly payments are made, the definition of first-party fraud can be narrowed in a predetermined manner (step 62). For example, in embodiments, the first-party fraud definition can be narrowed to include only fraud committed by a lender employee. If no fraud is detected and less than the predetermined number of monthly payments has been made when a claim is filed (step 64), the coverage conditions established when the mortgage insurance product issued can still all apply. In embodiments, the coverage conditions can be established by a Mater Policy between the insurance company and a particular lender.

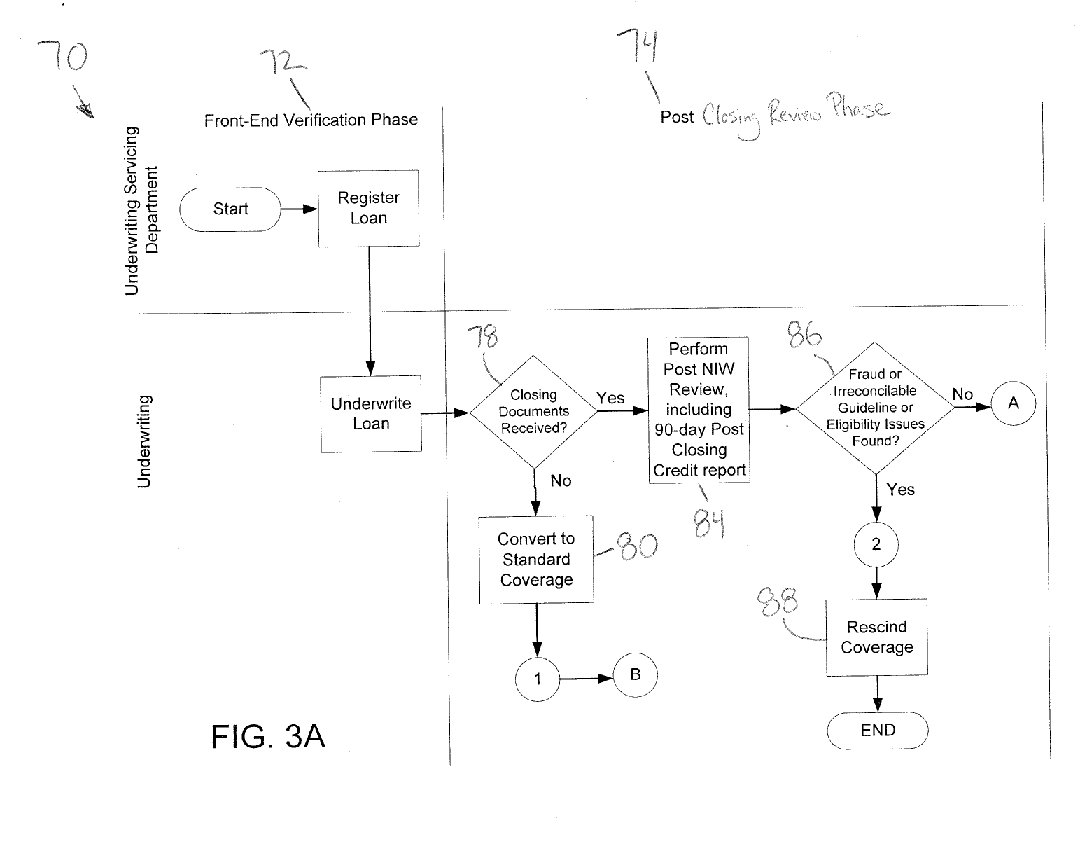

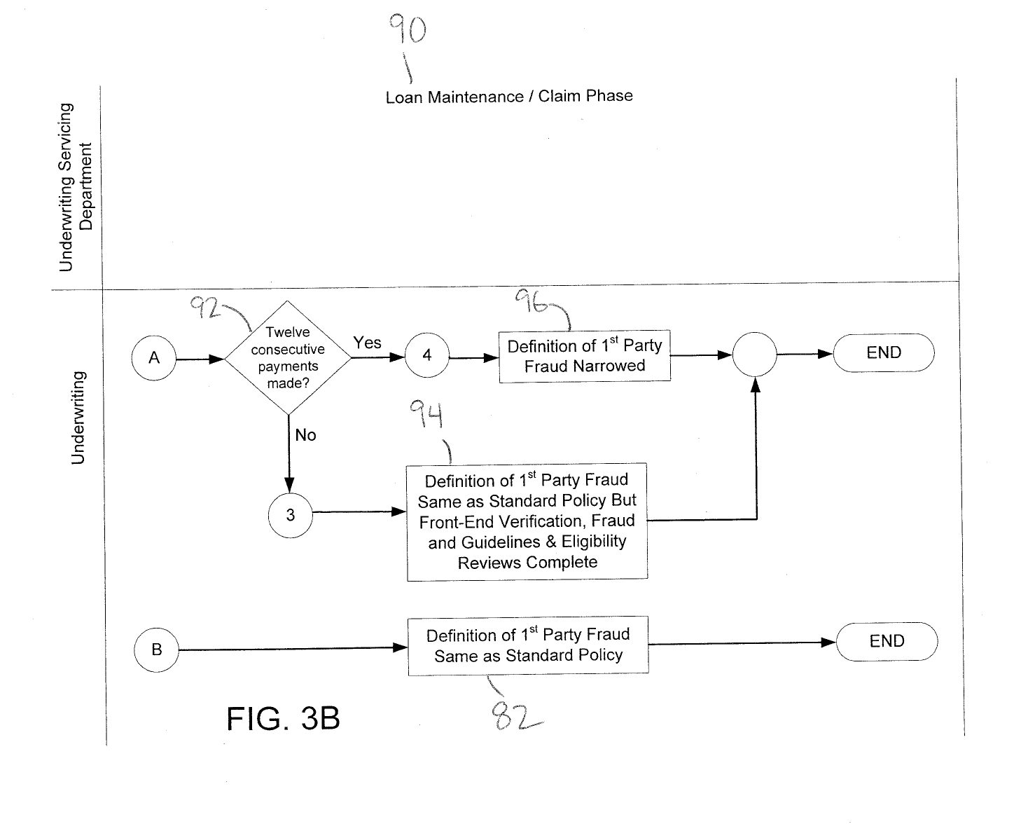

Referring to FIGS. 3A, and 3B, an embodiment of a method 70 of underwriting a mortgage insurance product according to principles of the present disclosure is shown. During a front-end verification phase 72, all underwriting support reports have been ordered and received. All origination documents have been received.

During a post-closing review phase 74, the lender submits closing documents to the insurer within a predetermined amount of time (step 78). In the illustrated embodiment, the predetermined time is within thirty days of closing. At process flow point 1, the insurer did not receive closing documents within the specified time period. The coverage of the issued mortgage insurance product can be considered to be a standard policy (step 80), including the definition of first party fraud (see FIG. 3B) (step 82), and can be subjected to further underwriting evaluation at the time a claim is filed.

Referring to FIG. 3A, at process flow point 2, the loan did not pass the front-end verification 72 and/or the post-closing review (step 84) revealed fraud, or irreconcilable guideline or eligibility issues (step 86). Under such conditions, the insurer can rescind coverage for the loan (step 88).

By employing a method of underwriting according to principles of the present disclosure, the insurer can review the loan for guidelines and eligibility issues during the post-closing review phase prior to a claim having been filed. By requiring the lender to submit closing documents within a predetermined period of time after closing (e.g., thirty days) and limiting the post-closing review phase to a predetermined amount of time (e.g., within ninety-seven days after closing), the underwriting method of the present disclosure can allow the insurer to determine at an earlier stage than would be otherwise possible if coverage should be revoked. By making the revocation determination at an earlier point in time, the insurer can free up capital reserves for other uses.

Referring to FIG. 3B, during the loan maintenance/claim phase 90 at process flow point 3, the loan passed the front-end verification 72 and the post-closing review 74. However, the borrower did not make the predetermined number of consecutive periodic payments under the loan (in the illustrated embodiment, twelve monthly payments) (step 92). Under such conditions, the insurer can maintain the conditions under which coverage can be denied for fraud. The insurer can agree, however, that no claim will be denied for a lack of documentation or for underwriting defects regarding the failure to meet guidelines and eligibility requirements (step 94). The documentation received during the front-end verification phase and the post-closing review phase can be retained for further use at the time a claim is filed.

Referring to FIG. 3B, during the loan maintenance/claim phase at process flow point 4, the loan has passed the front-end verification 72 and the post-closing review 74. The borrower has also made the predetermined number of consecutive periodic payments under the loan (in the illustrated embodiment, twelve monthly payments) (step 92). Under such conditions, the insurer can narrow the conditions under which coverage can be denied for fraud (step 96). For example, in the illustrated embodiment, the definition of first party fraud can be narrowed to include only fraud committed by a lender employee or officer. Furthermore, the insurer can also agree that no claim will be denied for a lack of documentation or for underwriting defects regarding the failure to meet guidelines and eligibility requirements.

By employing a method of underwriting according to principles of the present disclosure, the guidelines and eligibility reviews have been completed prior to receiving a claim for a particular loan covered by a mortgage insurance product. The lender has increased assurance of coverage at the time of the claim. The insurer is able to render a decision on a claim in a shorter amount of time after receiving the claim than otherwise would be possible. There can also be a reduced likelihood of investor buyback demand as a result of fraud.

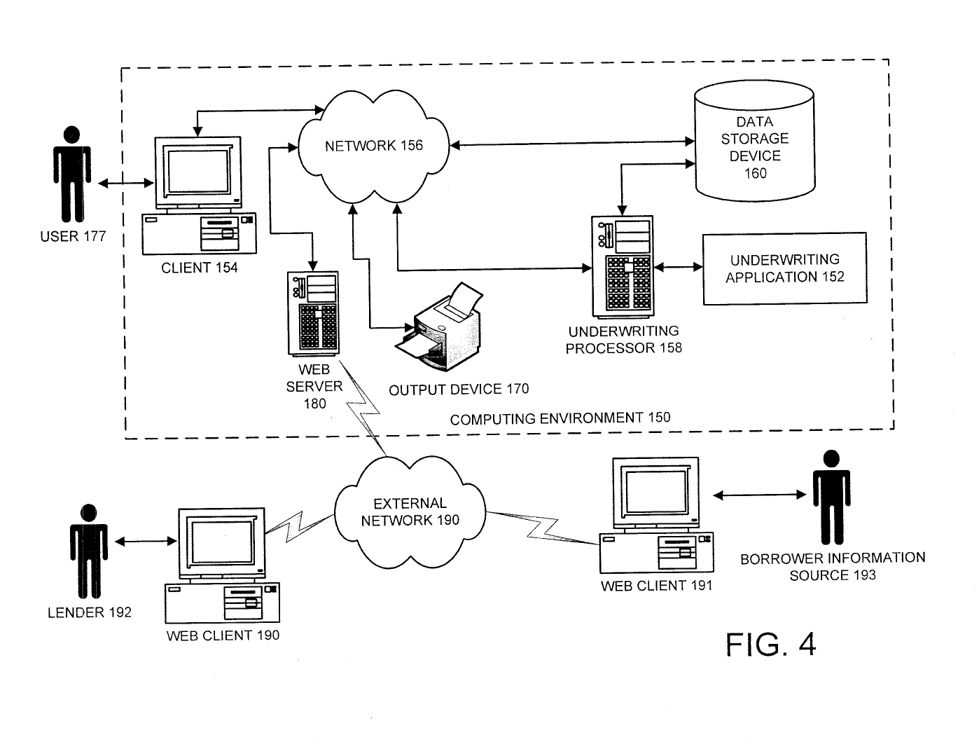

Referring to FIG. 4, an embodiment of a computing environment 150 is shown that includes an underwriting program 152 for underwriting a mortgage insurance product. The underwriting program 152 can be stored on a physical computer-readable medium. The computing environment 150 constitutes a computer-implemented system for underwriting a mortgage insurance product for a mortgage between a borrower and a lender. The computing environment 150 can include a number of computer systems, which generally can include any type of computer system based on: a microprocessor, a mainframe computer, a digital signal processor, a portable computing device, a personal organizer, a device controller, or a computational engine within an appliance. In some embodiments, the computer environment 150 is implemented in one or more electronic devices that are located in one or more locations.

The illustrated computing environment 150 can include a client 154, an internal network 156, at least one underwriting processor 158 operating the underwriting program 152, a data storage device 160, an output device 170, and a web server 180 operatively connected to an external network 190. The client 154, the underwriting processor 158, the data storage device 160, the output device 170, and the web server 180 are operatively connected together via the internal network 156.

A plurality of web clients 190, 191 can use the computing environment 150 to interface with the insurance provider operating the computing environment 150. For example, a lender 192 can use the web client 190 to receive information from, and to transmit information to, the insurance provider's computing environment 150 about the underlying loan that is the subject of the mortgage insurance product. A borrower information source 193 can use the web client 191 to transmit borrower credit history data from the web client 191 for use by the underwriting program 152. The insurance provider can be communicatively connected with one or more partner sites (such as the two shown—the lender 192 and the borrower information source 193) and its customers via the external network 190. In some embodiments, the borrower can use another web client to communicate with the underwriting program 152 over the external network 190. In other embodiments, a different communication channel can be established between the lender, the borrower information source, the borrower, etc. and the underwriting program 152 to transmit data feeds to the underwriting program 152. In still other embodiments, the insurance provider can use another communication channel, such as a telephone network, for example, to communicate with the lender, the borrower, and/or the borrower information source.

The client 154 can be used to communicate with an authorized user 177 to enter mortgage insurance product data into the data storage device 160, to communicate with the web clients 190, 191, and/or to execute the underwriting program 152. The client 154 can comprise at least one input device. The client 154 can generally include any node on a network including computational capability and including a mechanism for communicating across the network 156.

In one embodiment, the client 154 hosts an application front end of the underwriting program 152. The application front end can generally include any component of the underwriting program 152 that can receive input from the user 177 or the client 154, communicate the input to the underwriting program 152, receive output from the underwriting program 152, and present the output to the user 177 and/or the client 154. In one embodiment, the application front end can be a stand-alone system.

The network 156 can generally include any type of wired or wireless communication channel capable of coupling together computing nodes. Examples of a suitable network 156 include, but are not limited to, a local area network, a wide area network, or a combination of networks.

The underwriting processor 158 operates the underwriting program 152 which can be stored upon a non-transitory, tangible computer-readable medium. The underwriting processor 158 can generally include any computational node including a mechanism for servicing requests from a client for computational resources, data storage resources, or a combination of computational and data storage resources. Furthermore, the underwriting processor 158 can generally include any system that can host the underwriting program 152. The underwriting processor 158 can generally include any component of an application that can receive input from the web clients 190, 191 via the web server 180 and from the client 154 through the network 156, process the input, and present the output to the underwriting program 152, the client 154, the web server 180, and/or the data storage device 160. The underwriting processor 158 can generally include any component of an application that can process data, interact with the data storage device 160, and execute logic for the underwriting program 152.

The underwriting program 152 comprises a computer program product residing on a non-transitory, tangible computer readable medium having a plurality of instructions stored thereon which, when executed by the underwriting processor 158, cause the processor 158 to perform steps associated with underwriting a mortgage insurance product as described herein. The underwriting program 152 can be any suitable computer-implemented application for processing information exchanged with the client 154 and/or the web clients 190, 191 via a web platform such as those known to one of ordinary skill in the art. The underwriting program 152 can contain computer executable instructions adapted to exchange information in the form of data with the data storage device 160. The underwriting program 152 can include a graphical user interface which can facilitate the input of loan, borrower, and other underwriting information into the underwriting program 152.

In embodiments, the underwriting program 152 includes a post-closing underwriting module adapted to perform a post-closing fraud analysis using loan information received from a first partner site 190 and can be adapted for use in performing at least a portion of a post-closing borrower credit review using the borrower credit information received from a second partner site 191 within a predetermined period of time after the loan has closed and before a claim under the mortgage insurance product has been received. In embodiments, the underwriting program 152 includes a loan information module adapted to collect loan information from the first partner site 190 through a plurality of data fields. In embodiments, the post-closing underwriting module of the underwriting program 152 includes a calendar application adapted to schedule a credit report order with the second partner site 191 within a predetermined range of time after the loan has closed for use in performing the post-closing borrower credit review. The range of time can be varied in different embodiments. Preferably, the range of time is between about 60 days and about 120 days, and more preferably between about 60 days and about 100 days.

In embodiments, the underwriting program 152 includes a monitoring module adapted to determine whether the borrower has made a predetermined number of consecutive payments during a loan maintenance phase. If the monitoring module determines the borrower has made the predetermined number of consecutive payments, the monitoring module can be adapted to provide an indication that a set of conditions under which coverage under the mortgage insurance product is denied is narrowed in a predetermined manner. Examples of such conditions are described above.

The architecture solution of the underwriting program 152 is flexible and scalable to include additional information for different mortgage insurance products offered by the insurance provider and to include additional loan information requirements for the various products offered by the insurance provider. In embodiments, the underwriting program 152 includes other modules and computer-executable instructions adapted to carry out other steps and features of a method for underwriting a mortgage insurance product following principles of the present disclosure. Any suitable computer-readable storage medium can be utilized for the underwriting program 152, including, for example, hard drives, floppy disks, CD-ROM drives, tape drives, zip drives, flash drives, optical storage devices, magnetic storage devices, and the like. The client 154 can be used by an authorized user 177 to help administer the underwriting program 152.

The database or data storage device 160 can generally include any type of system for storing data in non-volatile storage. This includes, but is not limited to, systems based upon: magnetic, optical, and magneto-optical storage devices, as well as storage devices based on flash memory and/or battery-backed up memory. In embodiments, the data storage device 160 is operably arranged with the processor 158 and is adapted to store a set of loan origination documents and a set of loan closing documents for each mortgage for which a mortgage insurance product has been issued. In one embodiment, the database 160 contains information associated with the various mortgage insurance products provided by the insurance provider and loan information associated with loans that are the subject of mortgage insurance products issued by the insurance provider and loans that are the subject of applications for mortgage insurance products offered by the insurance provider. This information can be used by the underwriting program 152 to perform a method of underwriting a mortgage insurance product according to principles of the present disclosure. The data storage device 160 can contain a permission database which stores user credentials and permissions specific to active users 177, lenders 192, borrower information sources 193, and borrowers that interact with the computing environment 150.

The output device 170 can comprise a printer, a display monitor, and a connection to another device, for example. The output device 170 can be used to generate reports for sending to the lender 192 which contain information generated by the underwriting program 152 about the mortgage insurance products issued by the insurance provider for loans originated or being serviced by the lender 192. The output device 170 can be used to generate reports for sending to the borrower information source 193 which contain information requests generated by the underwriting program 152 about borrowers of the loans underlying the mortgage insurance products issued by the insurance provider. The output device 170 can be used to communicate to the user 177 information generated by the underwriting program 152 about the mortgage insurance products issued by the insurance provider.

A report engine can be provided to generate displays of information stored in the data storage device 160 concerning the mortgage insurance products issued by the insurance provider, which can be viewed using the output device 170, for example. In one embodiment, the report engine further provides pre-configured and/or ad hoc reports relating to the underwriting status of the mortgage insurance products issued by and/or under evaluation for issuance by the insurance provider.

The web server 180 can provide a suitable web site or other Internet-based graphical user interface which is accessible by the lender (or his agent/broker) 192 and the borrower information sources 193 providing borrower information data feeds, such as borrower credit history information, for example. The web server 180 can serve as a web-enabled interface adapted to exchange information with a first partner site 190, including to receive loan information and to send mortgage insurance information generated by the underwriting program, and a second partner site 191, including to receive borrower credit information. In other embodiments, other partner sites be connected to the web-enabled interface, such as other lenders, other partner sites providing borrower credit information, and partner sites providing mortgage fraud detection analysis services.

The web server 180 can provide access to an internet-based web platform that includes the underwriting program 152. In some embodiments, the web server 180 can be adapted to host a web site, to execute enterprise applications, to deliver web pages and other content upon request to web clients, and to receive content from web clients. The web clients 190, 191 can be connected to the web server 180 through the network connection 190 (e.g., Internet, Intranet, LAN, WAN and the like). The web server 180 can use an authentication server in order to validate and assign proper permissions to authorized users of the system. A permission database can store web user credentials and permissions specific to each user, investor, agent, broker, market information source, etc. The web server 180 can be outfitted with a firewall such that requests originating from outside the computing environment 150 pass through the firewall before being received and processed at the web server 180.

In addition to the components discussed above, the computing environment 150 can further include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases.

In yet other embodiments, the computing environment can include an electronic common repository for electronic documents relating to mortgage insurance products issued by the insurance provider and the associated underlying loans. The electronic common repository can be used by users 177, lenders 192, borrower information sources 193, and others according to a set of authorized permissions to the respective party to upload electronic documents generated at different times of the process from loan origination through claim processing.

In embodiments of a method for underwriting a mortgage insurance product for a mortgage between a borrower and a lender, loan information regarding the mortgage is received through a network including a web-enabled interface. A processor is employed to execute computer-executable instructions stored on a physical computer-readable medium. The computer-executable instructions perform underwriting steps. A post-closing fraud analysis is performed within a predetermined time range after the mortgage closed and before a claim under the mortgage insurance product has been received using the received loan information. Borrower credit information is received through the network within the predetermined time range after the mortgage closed. At least a portion of a post-closing borrower credit review is performed using the received borrower credit information. A plurality of data fields adapted to collect loan information can displayed in a graphical user interface to facilitate the receipt of loan information. A credit report order through the network with a partner site can be scheduled within the predetermined time range after the mortgage closed for use in performing the post-closing borrower credit review.

In embodiments, an electronic set of loan origination documents and an electronic set of loan closing documents for the mortgage are stored in a data storage device operably arranged with the processor. The electronic set of closing documents can be compared to the electronic set of loan origination documents to determine whether any differences constituting a defect are present.

In embodiments, the computer executable instructions stored on the tangible computer-readable medium perform a step of determining whether the borrower has made a predetermined number of consecutive payments during a loan maintenance phase. If the borrower has made the predetermined number of consecutive payments during the loan maintenance phase and prior to a claim being filed, the computer executable instructions stored on the tangible computer-readable medium perform a step of providing an indication that a set of conditions under which coverage under the mortgage insurance product is denied is narrowed in a predetermined manner.

In other embodiments, systems and methods of underwriting mortgage insurance products can be implemented on various types of computer architectures, such as for example on a single general purpose computer or workstation, on a networked system, in a client-server configuration, or in an application service provider configuration. Additionally, the methods and systems described herein may be implemented on many different types of processing devices by program code comprising program instructions that are executable by the device processing subsystem. The software program instructions may include source code, object code, machine code, or any other stored data that is operable to cause a processing system to perform methods described herein. Other implementations may also be used, however, such as firmware or even appropriately designed hardware configured to carry out the methods and systems described herein.

The systems' and methods' data (e.g., associations, mappings, etc.) may be stored and implemented in one or more different types of computer-implemented ways, such as different types of storage devices and programming constructs (e.g., data stores, RAM, ROM, flash memory, flat files, databases, programming data structures, programming variables, IF-THEN (or similar type) statement constructs, etc.). It is noted that data structures describe formats for use in organizing and storing data in databases, programs, memory, or other tangible computer-readable media for use by a computer program.

The computer components, software modules, functions, data stores and data structures described herein may be connected directly or indirectly to each other in order to allow the flow of data needed for their operations. It is also noted that a module or processor can include but is not limited to a unit of code that performs a software operation, and can be implemented, for example, as a subroutine unit of code, a software function unit of code, an object (as in an object-oriented paradigm) or an applet and can be implemented in a computer script language or another type of computer code. The software components and/or functionality (e.g., the fraud detection scorecard functionality) may be located on a single computer or distributed across multiple computers depending upon the particular circumstances surrounding its use (e.g., located on client and/or server computers).

In various embodiments, methods of underwriting mortgage insurance products in accordance with principles of the present disclosure operate as software programming operating on a computer processor. Dedicated hardware implementations, including, but not limited to, application-specific integrated circuits, programmable logic arrays and other hardware devices, can likewise be constructed to implement the methods described herein. Furthermore, alternative software implementations, including, but not limited to, distributed processing or component/object distributed processing, parallel processing, or virtual machine processing, can also be constructed to implement the methods described herein.

In various embodiments, an underwriting program in accordance with principles of the present disclosure can take the form of a computer program product on a tangible, computer-readable storage medium having computer-readable program code means embodied in the storage medium. Software implementations of the program for underwriting as described herein can be stored on any suitable tangible storage medium, such as: a magnetic medium such as a disk or tape; a magneto-optical or optical medium such as a disk; or a solid state medium such as a memory card or other package that houses one or more read-only (non-volatile) memories, random access memories, or other re-writable (volatile) memories. A digital file attachment to email or other self-contained information archive or set of archives is considered a distribution medium equivalent to a tangible storage medium. Accordingly, a tangible storage medium includes a distribution medium and art-recognized equivalents and successor media, in which the software implementations herein are stored.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A computer-implemented system for underwriting a mortgage insurance product for a mortgage between a borrower and a lender comprising:
a physical computer-readable medium including an underwriting program;
a processor adapted to execute the underwriting program; and
a web-enabled interface adapted to exchange information with a first partner site, including to receive loan information and to send mortgage insurance information generated by the underwriting program, the web-enabled interface adapted to exchange information with a second partner site, including to receive borrower credit information;
wherein the underwriting program includes a post-closing underwriting module adapted to perform a post-closing fraud analysis using the loan information received from the first partner site and adapted for use in performing at least a portion of a post-closing borrower credit review using the borrower credit information received from the second partner site within a predetermined period of time after the loan has closed and before a claim under the mortgage insurance product has been received.

2. The computer-implemented system for underwriting a mortgage insurance product according to claim 1, further comprising:
a data storage device operably arranged with the processor and adapted to store a set of loan origination documents and a set of loan closing documents for the mortgage.

3. The computer-implemented system for underwriting a mortgage insurance product according to claim 1, wherein the underwriting program includes a loan information module adapted to collect loan information from the first partner site through a plurality of data fields.

4. The computer-implemented system for underwriting a mortgage insurance product according to claim 1, wherein the post-closing underwriting module of the underwriting program includes a calendar application adapted to schedule a credit report order with the second partner site within a predetermined range of time after the loan has closed for use in performing the post-closing borrower credit review.

5. The computer-implemented system for underwriting a mortgage insurance product according to claim 1, wherein the range of time is between about 60 days and about 120 days.

6. The computer-implemented system for underwriting a mortgage insurance product according to claim 1, wherein the underwriting program includes a monitoring module adapted to determine whether the borrower has made a predetermined number of consecutive payments during a loan maintenance phase.

7. The computer-implemented system for underwriting a mortgage insurance product according to claim 6, wherein if the monitoring module determines the borrower has made the predetermined number of consecutive payments, the monitoring module is adapted to provide an indication that a set of conditions under which coverage under the mortgage insurance product is denied is narrowed in a predetermined manner.

8. A method for underwriting a mortgage insurance product for a mortgage between a borrower and a lender comprising:
receiving, through a network including a web-enabled interface, loan information regarding the mortgage;
employing a processor to execute computer-executable instructions stored on a physical computer-readable medium, the computer-executable instructions performing steps including:
performing, within a predetermined time range after the mortgage closed and before a claim under the mortgage insurance product has been received, a post-closing fraud analysis using the received loan information,
receiving, through the network, borrower credit information within the predetermined time range after the mortgage closed,
performing at least a portion of a post-closing borrower credit review using the received borrower credit information.

9. The method for underwriting a mortgage insurance product according to claim 8, further comprising:
storing an electronic set of loan origination documents and an electronic set of loan closing documents for the mortgage in a data storage device operably arranged with the processor.

10. The method for underwriting a mortgage insurance product according to claim 9, further comprising:
comparing the electronic set of closing documents to the electronic set of loan origination documents to determine whether any differences constituting a defect are present.

11. The method for underwriting a mortgage insurance product according to claim 8, wherein the computer executable instructions stored on the tangible computer-readable medium perform a step of: displaying in a graphical user interface a plurality of data fields adapted to collect loan information.

12. The method for underwriting a mortgage insurance product according to claim 8, wherein the computer executable instructions stored on the tangible computer-readable medium perform a step of: scheduling through the network a credit report order with a partner site within the predetermined time range after the mortgage closed for use in performing the post-closing borrower credit review.

13. The method for underwriting a mortgage insurance product according to claim 8, wherein the computer executable instructions stored on the tangible computer-readable medium perform a step of: determining whether the borrower has made a predetermined number of consecutive payments during a loan maintenance phase.

14. The method for underwriting a mortgage insurance product according to claim 13, wherein, if the borrower has made the predetermined number of consecutive payments during the loan maintenance phase and prior to a claim being filed, the computer executable instructions stored on the tangible computer-readable medium perform a step of: providing an indication that a set of conditions under which coverage under the mortgage insurance product is denied is narrowed in a predetermined manner.

15. A non-transitory, tangible computer-readable storage medium bearing computer executable instructions for underwriting a mortgage insurance product for a mortgage between a borrower and a lender, the instructions, when executing on one or more computing devices, performing the steps of:
performing, within a predetermined time range after the mortgage closed and before a claim under the mortgage insurance product has been received, a post-closing fraud analysis using loan information collected from a plurality of data fields,
receiving borrower credit information within the predetermined time range after the mortgage closed,
performing at least a portion of a post-closing borrower credit review using the received borrower credit information.

16. The non-transitory, tangible computer-readable storage medium according to claim 15, wherein the computer executable instructions stored on the tangible computer-readable medium, when executing on one or more computing devices, perform a step of: displaying in a graphical user interface a plurality of data fields adapted to collect loan information.

17. The non-transitory, tangible computer-readable storage medium according to claim 15, wherein the computer executable instructions stored on the tangible computer-readable medium, when executing on one or more computing devices, perform a step of: scheduling through the network a credit report order with a partner site within the predetermined time range after the mortgage closed for use in performing the post-closing borrower credit review.

18. The non-transitory, tangible computer-readable storage medium according to claim 15, wherein the computer executable instructions stored on the tangible computer-readable medium, when executing on one or more computing devices, perform a step of: determining whether the borrower has made a predetermined number of consecutive payments during a loan maintenance phase.

19. The non-transitory, tangible computer-readable storage medium according to claim 18, wherein, if the borrower has made the predetermined number of consecutive payments during the loan maintenance phase and prior to a claim being filed, the computer executable instructions stored on the tangible computer-readable medium, when executing on one or more computing devices, perform a step of: providing an indication that a set of conditions under which coverage under the mortgage insurance product is denied is narrowed in a predetermined manner.
